(19) United States
(12) Patent Application Publication
(10) Pub. No.: US 2009/0094427 A1
(43) Pub. Date: Apr. 9, 2009

(54) CAPACITY EXPANSION CONTROL METHOD FOR STORAGE SYSTEM

(76) Inventor: TAKANORI SANO, Tokyo (JP)

Correspondence Address: NEC CORPORATION OF AMERICA, 6535 N. STATE HWY 161, IRVING, TX, 75039, US

(21) Appl. No.: 12/246,155

(22) Filed: Oct. 6, 2008

(30) Foreign Application Priority Data
Oct. 5, 2007 (JP) 2007-261622

(51) Int. Cl. G06F 12/16; G06F 13/00; G06F 12/02

(52) U.S. Cl. 711/162; 711/170; 711/E12.002; 711/E12.103

(57) ABSTRACT

The invention provides capacity expansion control method for a storage system capable of expanding capacities of source and target logical volumes paired with each other and difference maps thereof while maintaining the pair relation between the source and target logical volumes and the difference map information thereof, and a storage system having such a capacity expansion control method.

This application is based upon and claims the benefit of priority from Japanese Patent Application No. 2007-261622, filed on Oct. 5, 2007, the disclosure of which is incorporated herein in its entirety by reference.

### BACKGROUND OF THE INVENTION

1. Field of the Invention

The present invention relates to a storage system having a volume replication function, and particularly to a capacity expansion control method for expanding logical volumes in a storage system.

2. Description of the Related Art

The Computer system becomes large-scale, and a large amount of data is processed, and a larger amount of data is stored. An example of data storage devices (storage systems) is a disk array device in which a plurality of hard disks are integrated into one system. In general, a large amount of data is backed up by using a data replication technology, and stored in a disk array device as replicated and multiplexed data. A data storage area of the disk array device is divided as not physical arrangement but a plurality of logical volumes. Each of the plurality of logical volumes defines a storage area logically treated as one of the disks.

The logical volumes, data of which are replicated, are in a pair relation, and called a source logical volume and a target logical volume, respectively. The source logical volume is for performing an operation, and the target logical volume is for storing data replicated from the source logical volume. The logical volumes each have a difference map. During data replication, this difference map is used so that data is replicated block by block from the source logical volume performing an operation to the target logical volume. This block-by-block data replication using the difference map reduces the amount of data to be replicated, resulting in improvement of replication efficiency.

The difference map refers to an information management table indicating whether data in a block with a certain unit length in a logical volume has been updated or not. The source logical volume and the target logical volume are divided into block units having a certain unit length. The difference map holds differential information (bit strings) indicating whether the data in the block has been updated or not for each of the block units. BACKUP or RESTORE can be performed by computing the logical OR of the difference maps of the logical volumes and replicating only the data in the updated blocks. BACKUP means a processing to replicate data from a source logical volume to a target logical volume, while RESTORE means a processing to replicate data from a target logical disk to a source logical disk.

Using the difference maps, only the updated blocks may be replicated and hence the replication processing can be completed in a minimum period of time. For example, when performing BACKUP on one pair of logical volumes with 2 TB (terabytes) capacity, a period of about six hours minimum is required for completing synchronization (replication or copying). However, when only the updated blocks are replicated according to the difference maps, the period of time required for the replication can be shortened significantly. The period of time required for replication processing is increased even more due to various factors, including BACKUP operation for several pairs of logical volumes, load state of the disk array, and line speed (when logical volumes are replicated between disk array devices).

There are related art patent documents as follows, relating to storage systems for use in a computer system. Japanese Laid-Open Patent Publication No. 2006-113975 (Patent Document 1) describes a technique in which any data that has been lost during pairing operation is identified and information indicating the lost data is output. A computer system according to Patent Document 1 has a management server and a plurality of operational servers each having a storage system. Upon receiving a request for changing the pair state, the management server refers to management information to identify data to be lost from the logical volume due to change of the pair state. The identification of data prevents unintended loss of data.

Japanese Laid-Open Patent Publication No. 2006-251937 (Patent Document 2) discloses a technique for increasing a number of generations of target logical volumes that can be produced by suppressing consumption of management resources relating to source logical volumes. Japanese Laid-Open Patent Publication No. 2007-164674 (Patent Document 3) discloses a capacity expansion method which is capable of rapidly expanding logical volume capacity by adding a new HDD. Japanese Laid-Open Patent Publication No. H11-327803 (Patent Document 4) discloses a technique in which a plurality of logical volumes are integrated into an expanded logical unit and data is multiplexed in the expanded logical unit.

The related art patent documents relate to storage systems of a computer system and disclose technologies related to the present invention. However, none of them describes or suggests the problems and the means for solving the problems of present invention.

### SUMMARY

The related art patent documents described above disclose problems relating to a storage system and propose technologies for solving the problems. However, these related art technologies have problems as described below when expanding the capacity of a disk array device having a logical volume replication function within the disk array device or between the disk array devices.

In order to expand the capacity of a disk array device having a logical volume replication function, the pair relation between the source logical volume and the target logical volume must be cancelled. This cancellation of the pair relation destroys difference map information. Therefore, the pair relation is established again after performing the cancellation of the pair relation and expanding the operating logical volume (source logical volume) and a logical volume to be the target logical volume. When the backup function is utilized for the first time after the reestablishment of the pair relation, the entire storage area of the source logical volume must be copied since the difference map information has been destroyed. This means that a full copy is required from the source logical volume to the target logical volume. This backup copying requires an enormous period of time, and there is a demand for a capacity expansion method for solving this problem.

The present invention has been made in view of these problems. An exemplary object of the invention is to provide a method for controlling the capacity expansion of the logical volumes and difference maps of the source and target logical volumes while maintaining the pair relation between the source and target logical volumes and the difference map information thereof.

A capacity expansion control method for a storage system according to an exemplary aspect of the invention is characterized in that capacities of source and target logical volumes which are in a pair relation and difference maps thereof are expanded while maintaining the pair relation between the source and target logical volumes and the difference map information thereof.

A storage system according to an exemplary aspect of the invention has a pair control unit for controlling establishment and cancellation of pair relation and BACKUP/RESTORE between a source logical volume and a target logical volume; and a logical volume expansion unit for expanding the capacities of the logical volumes and difference maps of the source and target logical volumes. The storage system is characterized in that the pair control unit establishes a pair relation between specific source and target logical volumes, and the logical volume expansion unit expands the capacity of the logical volumes and the difference maps of the paired source and target logical volumes while maintaining the pair relation established by the pair control unit.

According to the exemplary aspect of the invention, capacities of source and target logical volumes and difference maps thereof can be expanded while maintaining the pair relation and difference map information of the source and target logical volumes. Since the pair relation and the difference map information are maintained, the BACKUP/RESTORE after the capacity expansion can be performed by block replication. Since only partial block replication is required instead of replication of the entire logical volume, the period of time required for the replication can be shortened considerably.

### BRIEF DESCRIPTION OF THE DRAWINGS

The above features and advantages of the present invention will be more apparent from the following description of certain preferred embodiments taken in conjunction with the accompanying, in with:

FIG. 1 is a related art system block diagram;

FIG. 2 is a system block diagram showing a first embodiment of the present invention;

FIG. 3 is a flowchart showing a related art capacity expansion procedure in REPLICATE mode;

FIG. 4 is a flowchart showing a capacity expansion procedure in REPLICATE mode and SEPARATE mode according to the first embodiment of the present invention;

FIG. 5 is a flowchart showing a related art capacity expansion procedure in SEPARATE mode;

FIG. 6 is a flowchart showing operation of a logical volume expansion operating unit according to the present invention;

FIG. 7 is a flowchart showing operation of a logical volume expansion unit according to the present invention;

FIG. 8 is a flowchart showing operation of processing (1) shown in FIG. 7;

FIG. 9 is a flowchart showing operation of processing (2) shown in FIG. 7;

FIG. 10 is a flowchart showing operation of processing (3) shown in FIG. 9;

FIG. 11 is a flowchart showing operation of processing (4) shown in FIG. 7; and

FIG. 12 is a system block diagram showing a second embodiment of the present invention.

### DETAILED DESCRIPTION OF EXEMPLARY EMBODIMENTS

Exemplary embodiments of the present invention will be described in detail with reference to the accompanying drawings.

### First Exemplary Embodiment

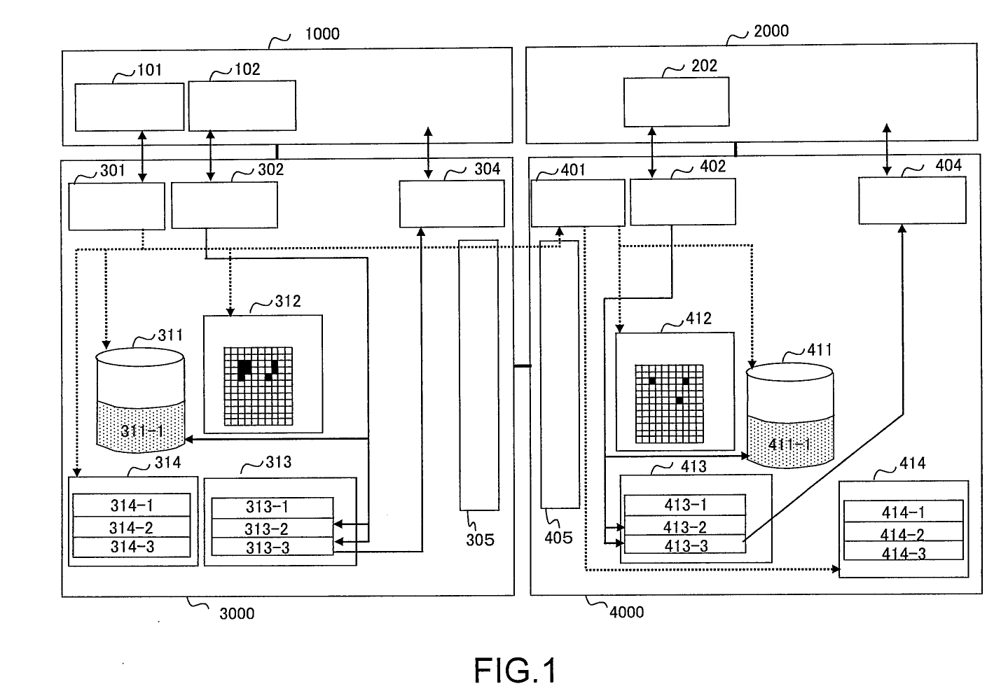

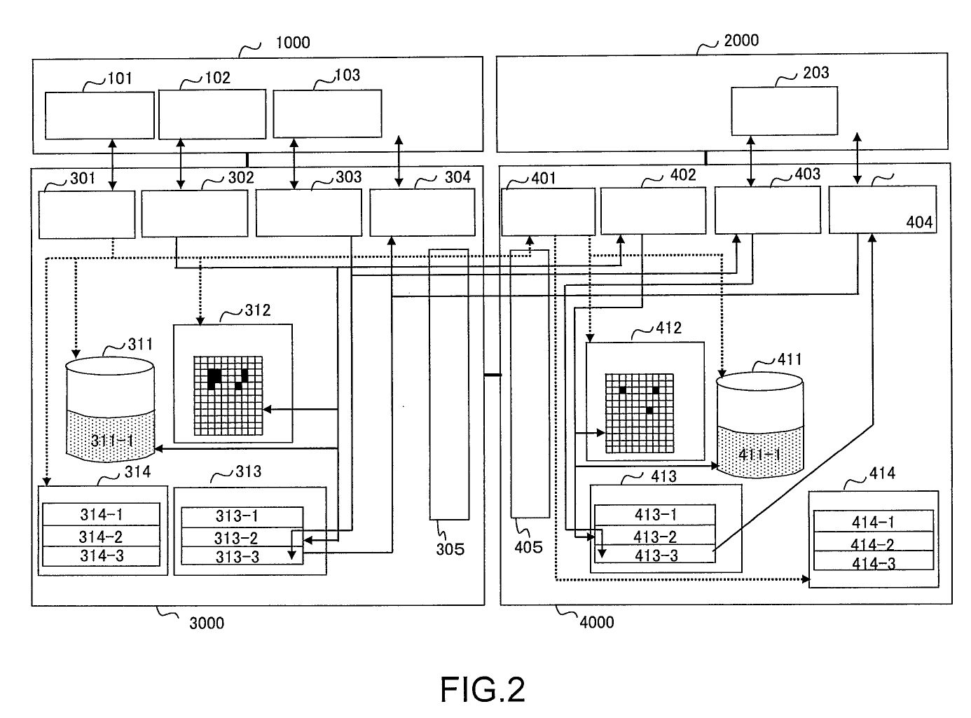

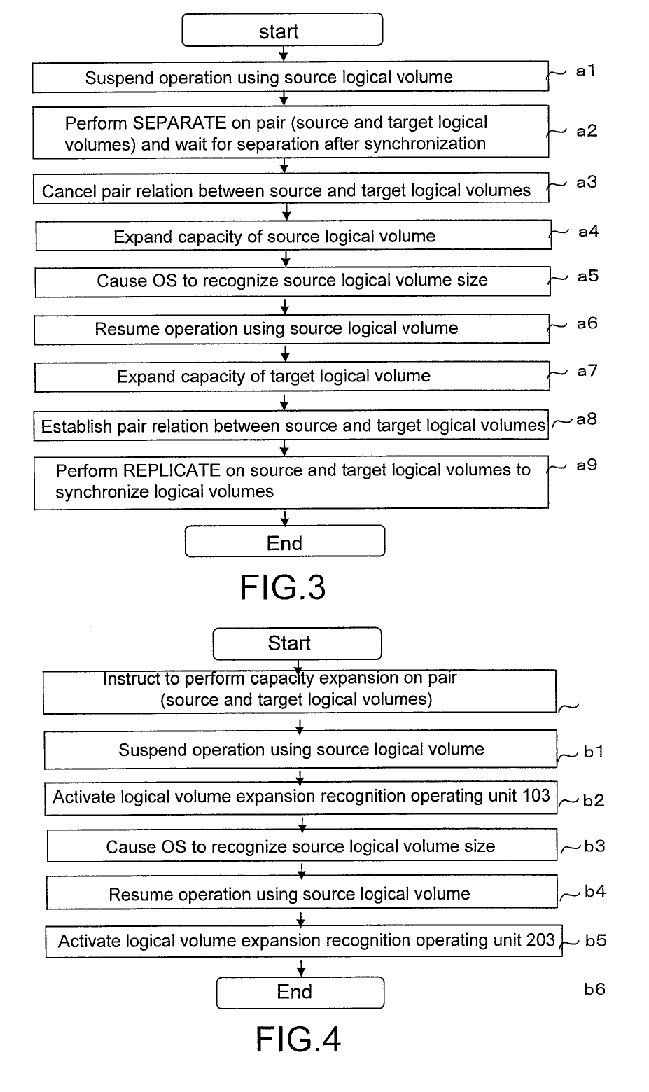

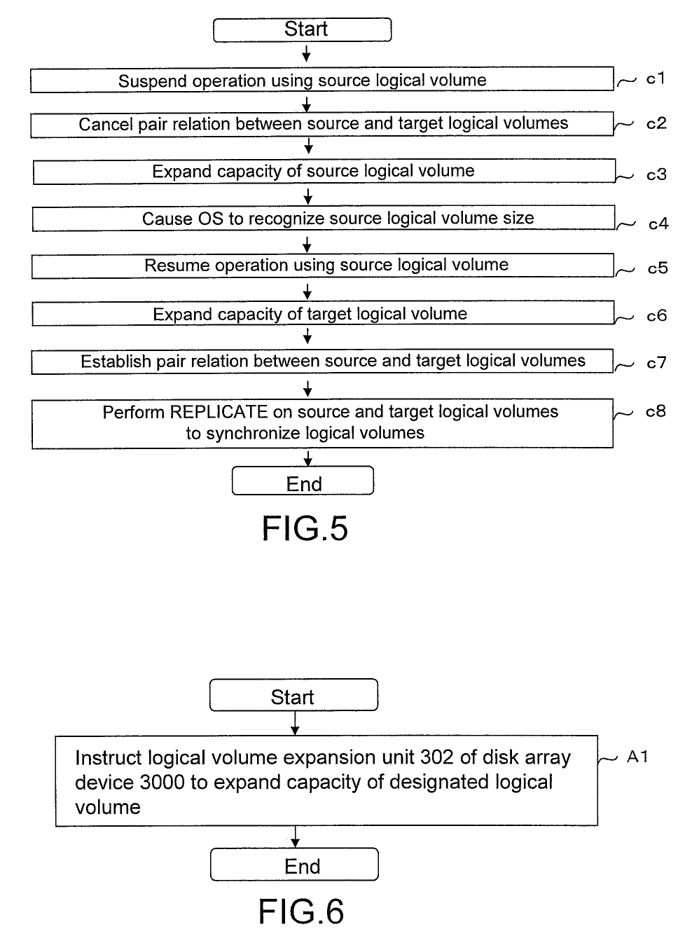

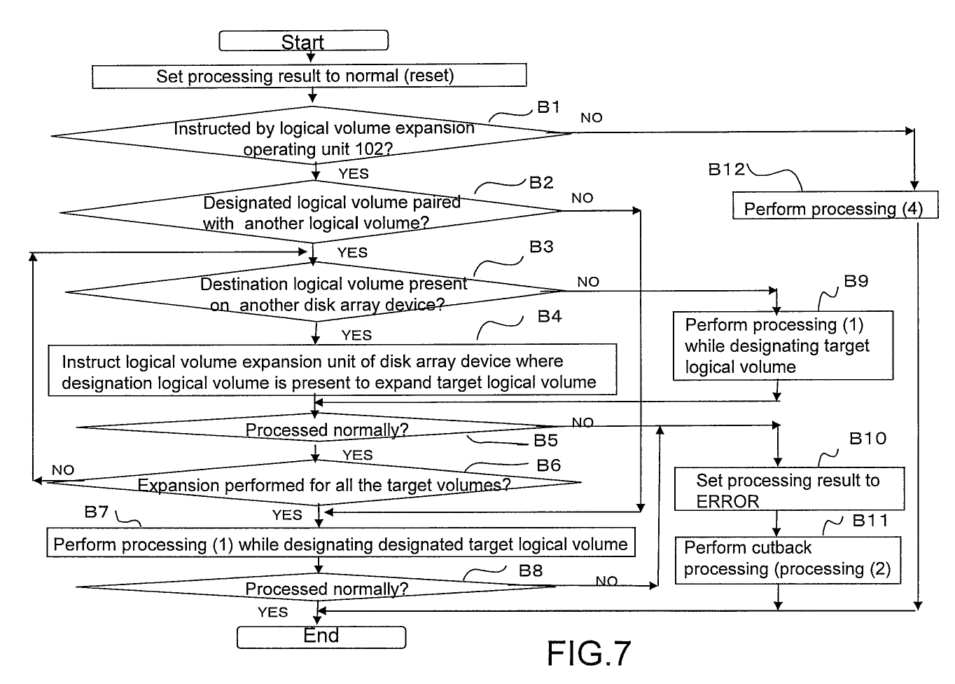

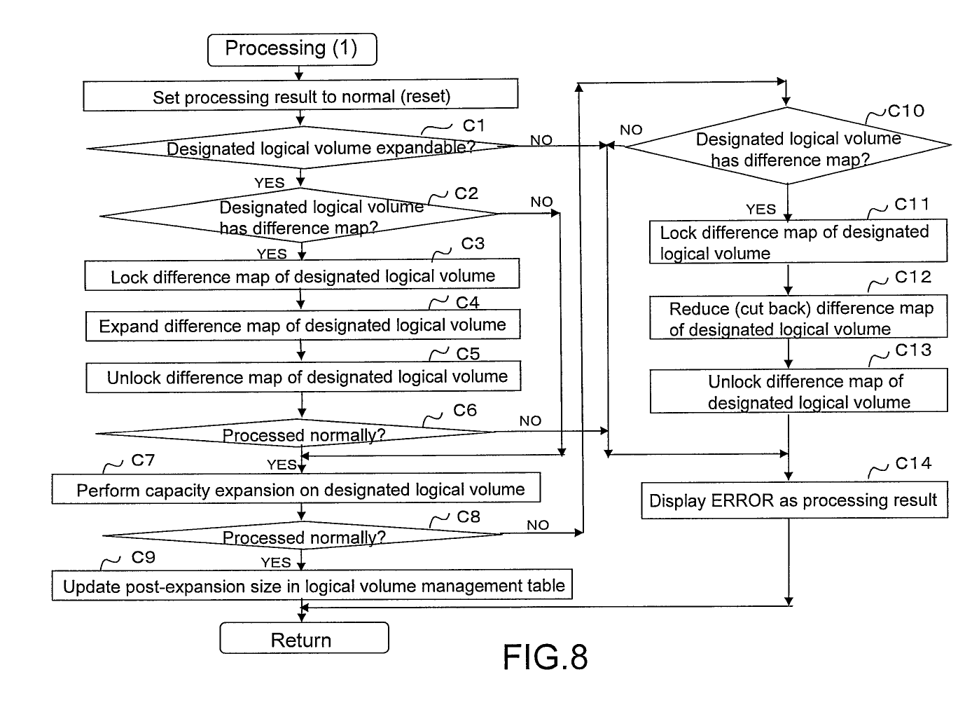

A first exemplary embodiment will be described in detail with reference to FIGS. 1 to 11. FIG. 2 shows a system block diagram according to the first embodiment. FIG. 4 is a flowchart showing a capacity expansion procedure in the REPLICATE mode and the SEPARATE mode according to the present invention. FIG. 6 shows an operational flowchart of a logical volume expansion operation unit according to the present invention. FIG. 7 shows an operational flowchart of the logical volume expansion unit according to the present invention, and detailed operational flowcharts of processing (1) to (4) therein are shown in FIGS. 8 to 11, respectively. A related art is shown in FIG. 1, FIG. 3, and FIG. 5 in order to facilitate the understanding of the embodiments of the present invention. FIG. 1 shows a system block diagram of the related art. FIGS. 3 and 5 show capacity expansion procedures in the REPLICATE mode and the SEPARATE mode, respectively, according to the related art.

The system shown in FIG. 2 is composed of servers 1000, 2000 and disk array devices 3000, 4000. The server 1000 in this system is a server for running a business application or the like, whereas the server 2000 is a server for running a backup application or the like. The disk array device 3000, which is connected to the server 1000 through a fiber channel, has a logical volume replication function between the disk array devices. The disk array device 4000, which is connected to the server 2000 through a fiber channel, also has a logical volume replication function between the disk array devices.

In the description of the present invention below, storage systems A and B are described as the disk array devices 3000 and 4000. However, the storage systems are not particularly limited to the disk array devices. The present invention is also applicable to some of disk array devices employing a plurality of hard disks or some of storage systems composed of a plurality of Floppy (registered trademark) disks or CD-ROMs. The present invention is applicable not only to storage media but to every type of storage systems.

The server 1000 has a pair operating unit 101, a logical volume expansion operating unit 102, and a logical volume expansion recognition operating unit 103, operating on the server 1000. These units operate according to an instruction input by the operator as described below.

Pair Operating Unit 101:

The pair operating unit 101 has a function to instruct a pair control unit 301 of the disk array 3000 to establish or cancel a pair relation between logical volumes, to perform BACKUP or RESTORE between logical volumes paired with each other. The pair operating unit 101 designates, as paired logical volume, those logical volumes which are present in the disk array devices 3000 and 4000, respectively, and have the same capacity. The pair operating unit 101 gives instructions to perform BACKUP or RESTORE on the paired logical volumes. A logical volume 311 in the disk array device 3000 serves as a source logical volume and a logical volume 411 in the disk array device 4000 serves as a target logical volume.

Logical Volume Expansion Operating Unit 102:

The logical volume expansion operating unit 102 has a function to instruct a logical volume expansion unit 302 to expand the capacity of the logical volume 311 present on the disk array device 3000.

Logical Volume Expansion Recognition Control Unit 103:

The logical volume expansion recognition operating unit 103 has a function to instruct a logical volume information setting unit 303 to set a post-expansion data size as the return data size in a logical volume management table 313.

The server 2000 has a logical volume expansion recognition operating unit 203 operating on the server 2000. This logical volume expansion recognition operating unit 203 operates as described below according to an instruction input by the operator.

Logical Volume Expansion Recognition Control Unit 203:

The logical volume expansion recognition operating unit 203 has a function to instruct a logical volume information setting unit 403 to set a post-expansion data size as the return data size in a logical volume management table 413.

The disk array device 3000 has a pair control unit 301, a logical volume expansion unit 302, a logical volume information setting unit 303, a logical volume information returning unit 304, and a communication control unit 305. Operation of the units of the disk array device 3000 will be described below.

Pair Control Unit 301:

The pair control unit 301 has a function to establish or cancel the pair relation between logical volumes and to perform BACKUP and RESTORE on logical volumes in the pair relation, according to an instruction by the pair operating unit 101. For example, the pair control unit 301 establishes or cancels the pair relation between the logical volume 311 of the disk array device 3000 and the logical volume 411 of the disk array device 4000. BACKUP is replication of data from the source logical volume 311 to the target logical volume 411. RESTORE is replication of data from the target logical volume 411 to the source logical volume 311.

When instructed to establish a pair relation, the pair control unit 301 computes a necessary difference map size based on the actual data size (actual capacity) of the source logical volume 311 and generates a difference map 312. The pair control unit 301 obtains a pair management table 314 and sets source volume information 314-1, target volume information 314-2, and pair information 314-3 therein. Further, the pair control unit 301 instructs the pair control unit 401 to obtain and set a difference map 412 and a pair management table 414 in the target logical volume 411. When instructed to cancel the pair relation, the pair control unit 301 releases the difference map 312 and the pair management table 314 of the logical volume 311. The pair control unit 301 instructs the pair control unit 401 to release the difference map 412 and the pair management table 414 of the target logical volume 411.

When instructed to perform BACKUP, the pair control unit 301 instructs the pair control unit 401 to obtain the difference map 412. The pair control unit 301 instructs the pair control unit 401 to compute the logical OR of the difference maps 312 and 412 and to update the target logical volume 411 with data in a block whose bit is ON. When instructed to perform RESTORE, the pair control unit 301 instructs the pair control unit 401 to acquire the difference map 412. The pair control unit 301 instructs the pair control unit 401 to compute the logical OR of the difference maps 312 and 412 and to transmit data in a block whose bit is ON of the target logical volume 411. The pair control unit 301 updates the source logical volume 311 using data obtained from the target logical volume 411.

Logical Volume Expansion Unit 302:

The logical volume expansion unit 302 has a function to expand the capacity of a logical volume designated by a logical volume expansion operating unit 102. The logical volume expansion unit 302 expands the capacity of the logical volume 311 if the logical volume 311 is not paired. When the logical volume can be expanded into a continuous region continuing from a region where the logical volume is present, the logical volume expansion unit 302 expands it into the continuous region. If the expansion into the continuous region is not possible, the logical volume expansion unit 302 expands the logical volume into a separate region other than the continuous region (discontinuous region). In this case, although the logical volume is divided into two regions, the original region before the expansion and the separate expansion region, the blocks in the logical volume form one continuous region. A new value is set in a post-expansion size 313-2 in the management table 313.

When the logical volume 311 is in the pair relation, the logical volume expansion unit 302 operates as described below. The logical volume expansion unit 302 instructs the logical volume expansion unit 402 to expand the capacity of the target logical volume 411 and the capacity of the difference map 412. After the capacity expansion of the target logical volume 411 and the difference map 412 has been completed successfully, the logical volume expansion unit 302 expands the source logical volume 311. Firstly, the logical volume expansion unit 302 checks whether or not the difference map 312 of the source logical volume 311 is expandable into a continuous region while maintaining the differential information. If expandable, the difference map 312 is expanded into the continuous region. If it is not expandable into the continuous region, the logical volume expansion unit 302 generates a new difference map, copies the existing differential information therein, and then destroys the old difference map.

The expanded portions of the logical volumes are initialized with the same value in both the source logical volume 311 and the target logical volume 411. This means that the difference between them is zero, and thus no differential information bits are required to be turned ON for the expanded portions of the difference maps. Since the difference map is accessed during a work-related IO processing, lock control should be performed appropriately. If the difference map cannot be expanded, the capacity of the difference map 412 of the target logical volume 411 is cut back to the original size. The logical volume expansion unit 302 instructs the logical volume expansion unit 402 of the disk array device 4000 to perform the cutback and returns an error message after completion of the cutback.

The logical volume expansion unit 302 then checks whether the capacity of the source logical volume 311 is expandable or not. If it is expandable into a continuous region, the logical volume expansion unit 302 expands the source logical volume 311 into the continuous region. If not expandable into a continuous region, the logical volume expansion unit 302 expands the source logical volume 311 into a region other than the continuous region. In this case, the blocks in the logical volume form one continuous region. If the capacity of the logical volume is not expandable due to insufficient physical disk space or the like, the logical volume expansion unit 302 instructs the logical volume expansion unit 402 of the disk array device 4000 to cut back the target logical volume 411. After completion of the cutback, the logical volume expansion unit 302 cuts back the difference map 312 to its original size and returns an error message. If all these processing are completed successfully, the logical volume expansion unit 302 updates a post-expansion size 313-2 of the logical volume management table 313 and returns a successful completion message.

Logical Volume Information Setting Unit 303:

The logical volume information setting unit 303 has a function to set the post-expansion size 313-2 as a return data size 313-3 of the logical volume management table 313 related to the logical volume 311, according to an instruction given by the logical volume expansion recognition operating unit 103.

Logical Volume Information Returning Unit 304:

The logical volume information returning unit 304 has a function to return to the server a value set as the return data size 313-3 of the logical volume management table 313. The logical volume information returning unit 304 returns the return data size 313-3 in response to a confirmation inquiry for the capacity of the logical volume 311 (SCSI command) sent by the server 1000 (operating system) according to an instruction input by the operator.

Communication Control Unit 305:

The communication control unit 305 has a function to control communications with the disk array device 4000. All the transmission of data and instructions to and from the disk array device 4000 is performed by way of the communication control unit 305.

In addition to the units described above, the disk array device 3000 has a logical volume 311, a difference map 312, a logical volume management table 313, and a pair management table 314. The logical volume 311 is a storage area which is logically treated as one disk, and serves as a source logical volume when it is paired. The logical volume 311 may have an expanded portion 311-1 (the region indicated by dotted lines in FIG. 2). Although only one logical volume 311 is shown in FIG. 2, the logical volume 311 may be provided in plurality. Each of the logical volumes is provided with one difference map 312. The difference map 312 is an information management table indicating whether or not data in a block with a certain unit length of the logical volume has been updated. The logical volume is divided into blocks having a certain unit length, and the difference map holds, for each of the blocks, differential information (bit strings) indicating whether or not the data in each of the blocks has been updated.

The logical volume management table 313 has, as information, a pre-expansion size 313-1, a post-expansion size 313-2, and a return data size 313-3 of the logical volume 311. The return data size 313-3 is a post-expansion size which is data to be returned to the logical volume information returning unit 304. The pair management table 314 has source volume information 314-1, target volume information 314-2, and pair information 314-3 indicating whether or not a pair relation is established.

The disk array device 4000 has a pair control unit 401, a logical volume expansion unit 402, a logical volume information setting unit 403, a logical volume information returning unit 404, and a communication control unit 405. Operation of these units will be described below.

Pair Control Unit 401:

The pair control unit 401 has a function to establish or cancel a pair relation of logical volumes according to an instruction given by the pair control unit 301 of the disk array device 3000. When instructed to establish a pair relation, the pair control unit 401 computes a necessary difference map size based on the actual data size (actual capacity) of the target logical volume 411 and generates a difference map 412. Further, the pair control unit 401 obtains a pair management table 414 to set source volume information 414-1, target volume information 414-2, and pair information 414-3 therein. When instructed to cancel the pair relation, the pair control unit 401 destroys the difference map 412 and the pair management table 414. When instructed by the pair control unit 301 to return the difference map, the pair control unit 401 returns information in the difference map 412. When BACKUP is performed, the pair control unit 401 updates the target logical volume 411 using data transmitted by the pair control unit 301. When RESTORE is performed, the pair control unit 401 acquires logical OR data of the difference map indicated by the pair control unit 301, and then transmits data in the block whose bit is ON to the pair control unit 301.

Logical Volume Expansion Unit 402:

The logical volume expansion unit 402 has a function to expand the capacities of the target logical volume 411 and the difference map 412 according to an instruction given by the logical volume expansion unit 302 of the disk array device 3000. The logical volume expansion unit 402 checks whether the difference map 412 of the target logical volume 411 is expandable into a continuous region while maintaining the differential information. When expandable, the logical volume expansion unit 402 expands the same into a continuous region. When not expandable into a continuous region, the logical volume expansion unit 402 generates a new difference map, copies the existing differential information therein, and then destroys the old difference map. The expanded portions of the logical volumes are initialized with the same value in both the source logical volume 311 and the target logical volume 411. Therefore, the difference between them is zero and thus no differential information bits are required to be turned ON for the expanded portion of the difference map. Since the difference map is accessed during a work-related IO processing, lock control should be performed appropriately. If the difference map cannot be obtained due to insufficient memory space, the logical volume expansion unit 402 returns an error message.

When the difference map is expanded successfully, the logical volume expansion unit 402 checks whether or not the capacity of the target logical volume 411 is expandable. If it is expandable into a continuous region, the logical volume expansion unit 402 expands the target logical volume 411 into the continuous region. If not expandable into a continuous region, the logical volume expansion unit 402 allocates a separate region as an expansion region and expands the target logical volume 411 into this region. In this case, the blocks in the logical volume form one continuous region. If the capacity of the logical volume is not expandable due to insufficient physical disk space, the logical volume expansion unit 402 performs a cutback processing on the difference map 412 and then returns an error message. If the logical volume capacity is expandable, the logical volume expansion unit 402 performs the capacity expansion. Upon completing all the capacity expansion processing successfully, the logical volume expansion unit 402 updates a post-expansion size 413-2 of the logical volume management table 413 related to the target logical volume 411, and returns a successful completion message. When instructed by the logical volume expansion unit 302 of the disk array device 3000 to cut back the capacities of the logical volume and the difference map, the logical volume expansion unit 402 cuts back the logical volume 411, the difference map 412, and the logical volume management table 413 to their original sizes.

Logical Volume Information Setting Unit 403:

The logical volume information setting unit 403 has a function to set a value of a post-expansion size 413-2 in a return data size 413-3 of the logical volume management table 413 related to the logical volume 411 indicated by the logical volume expansion recognition operating unit 203.

Logical Volume Information Returning Unit 404:

The logical volume information returning unit 404 has a function to return a value set as the return data size 413-3 of the logical volume management table 413. The logical volume information returning unit 404 returns the return data size 413-3 in response to a confirmation inquiry for the capacity of the logical volume 411 (SCSI command) sent by the server 2000 (operating system).

Communication Control Unit 405:

The communication control unit 405 has a function to control communication with the disk array device 3000. All the transmission of data and instructions to and from the disk array device 3000 is performed by way of this communication control unit 405.

In addition to the units described above, the disk array device 4000 has a logical volume 411, a difference map 412, a logical volume management table 413, and a pair management table 414. The logical volume 411 is a storage area which is logically treated as one disk, and serves a target logical volume when it is paired. The logical volume 411 may have an expanded portion 411-1 in the inside thereof (the region indicated by the dotted lines in FIG. 2). Although only one logical volume is shown in the figure as the logical volume 411, the logical volume 411 may be provided in plurality.

Each of the logical volumes is provided with a difference map 412. The difference map 412 is an information management table indicating whether data in a block with a certain unit length of the logical volume has been updated or not. The logical volume is divided into blocks having a certain unit length, and the difference map holds, for each of the blocks, differential information (bit strings) indicating whether or not the data in the block has been updated. The logical volume management table 413 has, as information, a pre-expansion size 413-1, a post-expansion size 413-2, and a return data size 413-3 of the logical volume. The return data size, corresponding to the post-expansion size, is data returned to the logical volume information returning unit 404. The pair management table 414 has source volume information 414-1, target volume information 414-2, and pair information 414-3 indicating whether a pair relation is established or not.

A related art system block diagram is shown in FIG. 1. This system is composed of servers 1000, 2000 and disk array devices 3000, 4000. Although the arrangement of the servers and the disk array devices is the same as the first embodiment of the present invention, units forming the servers and disk array devices are different. Principal differences between the units provided in systems according to the present invention and those according to the related art are as follows. The related art system is not provided with the logical volume recognition operation units 103, 203, or the logical volume information setting units 303, 403. The server 2000 is provided with a logical volume expansion operating unit 202. This logical volume expansion operating unit 202 operates according to an instruction input by the operator. The logical volume expansion unit 402 expands the capacity of the target logical volume 411 according to an instruction of the logical volume expansion operating unit 202. This means that the capacity expansion of the source logical volume and the capacity expansion of the target logical volume are performed by separate instructions.

The pair operating unit 101 operates according to an instruction input by the operator and gives instructions to the pair control unit 301. The logical volume expansion operating unit 102 operates according to an instruction input by the operator, and gives instructions to the logical volume expansion unit 302. The logical volume expansion operating unit 202 operates according to an instruction input by the operator, and gives instructions to the logical volume expansion unit 402.

The pair control unit 301 establishes or cancels a pair relation between logical volumes and performs BACKUP and RESTORE between the source and target logical volumes, according to an instruction by the pair operating unit 101. As for processing to the target logical volume, the pair control unit 301 gives instructions to the pair control unit 401. The logical volume expansion unit 302 expands the capacity of a logical volume designated by the logical volume expansion operating unit 102. The logical volume information returning unit 304 receives a confirmation inquiry for the capacity of the logical volume 311 (SCSI command) sent by the server's operating system (OS) according to an instruction input by the operator. The logical volume information returning unit 304 sends a return data size in the logical volume management table 313 to the OS to cause the OS to recognize the post-expansion size.

The pair control unit 401 establishes or cancels a pair relation between logical volumes and performs BACKUP and RESTORE between the source and target logical volumes, according to an instruction by the pair control unit 301. The logical volume expansion unit 402 expands the capacity of a logical volume designated by the logical volume expansion operating unit 202. The logical volume information returning unit 404 receives a confirmation inquiry for the capacity of the logical volume (SCSI command) sent by the server's operating system (OS) according to an instruction input by the operator. The logical volume information returning unit 404 sends a return data size in the logical volume management table 413 to the OS to cause the OS to recognize the post-expansion size.

The disk array devices 3000 and 4000 have logical volumes 311 and 411, difference maps 312 and 412, logical volumes management table 313 and 413, pair management tables 314 and 414, and communication control devices 305 and 405, respectively. Functions of these components are substantially the same as those of the system of the present invention. Operation of these units and components will be described later using operational flowcharts.

Referring to FIGS. 3 to 5, capacity expansion procedure according to the first embodiment of the invention will be described. FIG. 3 is a flowchart showing capacity expansion procedure in the REPLICATE mode according to the related art, and FIG. 5 is a flowchart showing capacity expansion procedure in the SEPARATE mode according to the related art. FIG. 4 is a flowchart showing capacity expansion procedure in the REPLICATE and SEPARATE modes according to the first embodiment.

The source logical volume and the target logical volume have two modes, namely REPLICATE mode and SEPARATE mode. The REPLICATE mode is a mode in which data is backed up from the source logical volume to the target logical volume. In this mode, the source and target logical volumes are either synchronized completely or being synchronized. They are deemed to have been synchronized when replication (copying) has been completed as the backup, whereas they are deemed to be being synchronized when the replication is underway. The SEPARATE mode is a mode in which the synchronization of the source and target logical volumes has been completed by the replication and the paired logical volumes have been separated from each other. Capacity expansion procedure in these two modes will be described while comparing the present invention with the related art.

I. Capacity Expansion Procedure in the REPLICATE Mode:

Related art capacity expansion procedure for expanding the capacity of paired logical volumes in the REPLICATE mode will be described with reference to FIG. 3. In the first step a1 of the procedure, the server 1000 suspends the operation using the source logical volume according to an instruction input by the operator. In step a2, the pair operating unit 101 operates according to an instruction input by the operator, and the pair control unit 301 implements SEPARATE. The pair control units 301 and 401 synchronize the paired (source and target) logical volumes. Waiting until they are synchronized and separated, the pair control units 301 and 401 check if the logical volumes have been separated by means of a command. In step a3, the pair operating unit 101 operates according to an instruction input by the operator, and the pair control unit 301 and 401 cancel the pair relation between the source logical volume and the target logical volume. The difference map information is destroyed by the cancellation of the pair relation.

In step a4, the logical volume expansion operating unit 102 operates according to an instruction input by the operator, and the logical volume expansion unit 302 expands the capacity of the source logical volume. Further, the logical volume information setting unit 303 sets the post-expansion size as a return data size in the logical volume management table 313. In step a5, the logical volume information returning unit 304 returns the return data size to the OS according to an instruction input by the operator, and causes the OS to recognize the post-expansion size. In step a6, the server 1000 resumes the operation using the source volume according to an instruction input by the operator.

In step a7, the logical volume expansion operating unit 102 operates according to an instruction input by the operator, and the logical volume expansion unit 402 expands the capacity of the target logical volume. Further, the logical volume information setting unit 403 sets the post-expansion size as the return data size in the logical volume management table 413. In step a8, the pair operating unit 101 operates according to an instruction input by the operator, and the pair control units 301 and 401 expand the source and target difference maps and establish a pair relation between the source and target logical volumes. In step a9, the pair operating unit 101 operates according to an instruction input by the operator, and the pair control unit 301 performs REPLICATE. The pair control units 301 and 401 synchronize the source and target logical volumes. Since the difference map information has been destroyed in step a3, the data in the logical volume must be fully copied.

Capacity expansion procedure according to the first embodiment of the invention will be described with reference to FIG. 4. In the first step b1, the logical volume expansion operating unit 102 operates according to an instruction input by the operator, and instructs the logical volume expansion unit 302 to expand the capacity of logical volumes. The logical volume expansion unit 302 instructs the logical volume expansion unit 402 to expand the capacity of the target logical volume and the difference map. Further, the logical volume expansion unit 302 expands the capacity of the source logical volume and the difference map. According to the present invention, the capacities of the source and target logical volumes and the difference maps thereof are expanded in the first step b1 by the logical volume expansion operating unit 102. This capacity expansion can be performed in the state in which the pair relation between the source and target logical volumes and the difference maps thereof are maintained and the server continues performing the operation.

After confirming the capacity expansion by means of a command, the server suspends the operation using the source logical volume in step b2, according to an instruction input by the operator. In step b3, the logical volume expansion recognition operating unit 103 is activated by an instruction input by the operator, and the logical volume information setting unit 303 sets the post-expansion size as the return data size. In step b4, according to an instruction input by the operator, the logical volume information returning unit 304 returns the post-expansion size of the source logical volume to the OS of the server 1000 to cause the OS to recognize it. According to an instruction input by the operator, a confirmation inquiry for the capacity of the logical volume 311 (SCSI command) is sent from the OS of the server 1000 to the logical volume information returning unit 304. The logical volume information returning unit 304 returns the return data size in the logical volume management table 313 to cause the server's OS to recognize the post-expansion data size.

In step b5, the server resumes the operation using the source logical volume according to an instruction input by the operator. In step b6, the logical volume expansion recognition operating unit 203 is activated by an instruction input by the operator, and the logical volume information setting unit 403 sets the post-expansion size as a return data size. Further, according to an instruction input by the operator, a confirmation inquiry for the capacity of the logical volume 411 (SCSI command) is sent from the server's OS to the logical volume information returning unit 404. The logical volume information returning unit 404 returns the return data size in the logical volume management table 413 to cause the server's OS to recognize the post-expansion data size. Since the target logical volume is not used in the REPLICATE mode, the processing of step b6 may be performed in step b3.

The Related Art Procedure has Problems as Described Below.

(1) The server operation must be suspended to ensure data integrity in the target logical volume, and SEPARATE (step a2) is implemented after the rest position is obtained. Moreover, the operation must be suspended until completion of initialization of an expanded portion (step a4) in order to prevent disturbance to the operation due to automatic recognition of a logical volume by the OS during the logical volume expansion. Due to these factors, the operation must be suspended early when capacity expansion is to be performed.

(2) In step a2, the source and target logical volumes are separated after being completely synchronized. Therefore, the period of time for which the operation is suspended becomes long if a difference is great.

(3) In step a9, the data must be fully copied for resynchronization, and hence a considerably long period of time is required before backing up the data. This means that the operation must be performed without backup (without fault tolerance) for a long period of time.

The related art procedure as described above has problems that the operation suspension time is prolonged and the operation must be performed without backup for a long period of time. In contrast, the present invention is free of these problems for the following reasons.

(1) The capacity expansion can be performed while continuing the operation. (The operation is suspended only for the period in which the OS is caused to recognize expansion information.)

(2) The procedure after step b2 can be performed at any time according to an operation schedule. Moreover, the operation suspension period is short.

(3) Resynchronization after the capacity expansion can be performed by block replication using the difference map, and hence the period of time required therefore is short. Thus, the system is backed up during the capacity expansion as well whiling maintaining high fault tolerance as a system.

II. Capacity Expansion Procedure in the SEPARATE Mode:

Related art capacity expansion procedure in the SEPARATE mode will be described with reference to FIG. 5. The capacity expansion according to the present invention can be performed by using the same procedure both in the REPLICATE and SEPARATE modes as shown in FIG. 4 and described above.

According to the related art capacity expansion procedure in the SEPARATE mode, in the first step c1, the server suspends the operation using the source logical volume according to an instruction input by the operator. In step c2, the pair operating unit 101 operates according to an instruction input by the operator, and the pair control units 301 and 401 cancel the pair relation between the source logical volume and the target logical volume. Differential map information is destroyed by the cancellation of the pair relation. In step c3, the logical volume expansion operating unit 102 operates according to an instruction input by the operator, and the logical volume expansion unit 302 expands the capacity of the source logical volume. Further, the post-expansion size is set as a return data size in the logical volume management table 313.

In step c4, according to an instruction input by the operator, the logical volume information returning unit 304 returns the return data size to the OS to cause the OS to recognize the data size after the capacity expansion. In step c5, the server resumes the operation using the source volume according to an instruction input by the operator. In step c6, the logical volume expansion operating unit 202 operates according to an instruction input by the operator, and the logical volume expansion unit 402 expands the capacity of the target logical volume. Further, the post-expansion size is set as a return data size in the logical volume management table 413.

In step c7, the pair operating unit 101 operates according to an instruction input by the operator, and the pair operation units 301 and 401 expand the source and target difference maps and establish a pair relation between the source and the target logical volumes. In step c8, the pair operating unit 101 operates according to an instruction input by the operator, and the pair operation unit 301 performs REPLICATE. The pair operation units 301 and 401 synchronize the source and target logical volumes. Since the difference map information has been destroyed in step c2, the data in the logical volumes must be fully copied, and thus a long period of time is required to complete the synchronization.

The related art capacity expansion procedure in the SEPARATE mode has problems as follows.

(1) In step c8, the data must be fully copied for resynchronization, which may increase the load on the disk array and thus may lead to delay in IO processing in the operation.

(2) In step c8, a considerably long period of time is required to complete the synchronization. Therefore, the operation must be performed for a long period of time without backup (without fault tolerance).

The capacity expansion procedure according to the present invention is safe and free of these problems both in the REPLICATE and SEPARATE modes. According to the present invention, the logical volumes and the difference maps are expanded with the pair relation and the difference maps being maintained while the server continues the operation. Then, expansion information after the capacity expansion is stored in the logical volume management table. The operation may be suspended at any desired time according to the operation schedule to cause the server's OS to recognize the expansion information. As a result, the operation suspension period is very short, and moreover the differential data is maintained and the backup is ensured during this period.

Referring to FIGS. 6 to 11, the operation procedure according to the invention will be described in detail. FIG. 6 shows operation procedure of the logical volume expansion operating unit 102 according to the present invention, and FIGS. 7 to 11 show operation procedure of the logical volume expansion units 302 and 402. The logical volume expansion unit 302 performs expansion or cutback processing according to an instruction of the logical volume expansion operating unit 102. The logical volume expansion unit 402 disposed in the separate disk array device 4000 performs expansion or cutback processing according to an instruction given by the logical volume expansion unit 302 in the same manner as the logical volume expansion unit 302.

As shown in FIG. 6, in step A1, the logical volume expansion operating unit 102 instructs the logical volume expansion unit 302 of the disk array device 3000 to expand capacity of designated logical volume. Actual expansion operation is performed by the logical volume expansion unit 302 instructed by the logical volume expansion operating unit 102.

Operation of the logical volume expansion unit 302 instructed to perform capacity expansion will be described with reference to FIG. 7. The logical volume expansion unit 302 resets the processing result and sets the processing result to normal. In step B1, the logical volume expansion unit 302 checks whether or not the capacity expansion is instructed by the logical volume expansion operating unit 102. If affirmative, the procedure proceeds to step B2, whereas if negative the procedure proceeds to step B12. In step B2, the logical volume expansion unit 302 checks whether or not the designated logical volume is paired with another logical volume. If affirmative, the procedure proceeds to step B3, whereas if negative the procedure proceeds to step B7. In step B3, the logical volume expansion unit 302 checks whether the target logical volume that is paired is present in another disk array device. If affirmative, the procedure proceeds to step B4, whereas if negative, the procedure proceeds to step B9.

In step B4, the logical volume expansion unit 302 instructs the logical volume expansion unit 402 of the disk array device in which the target logical volume is present to expand the designated target logical volume. In step B5, the logical volume expansion unit 302 checks whether or not the expansion operation has been performed normally by the logical volume expansion unit 402. If affirmative, the procedure proceeds to step B6, whereas, if negative, the procedure proceeds to step B10.

In step B6, the logical volume expansion unit 302 checks whether or not all the target logical volumes have been expanded. If affirmative, the procedure proceeds to step B7 whereas, if negative, the procedure returns to step B3 and the expansion processing is repeated for the remaining target logical volumes. When there are a plurality of target logical volumes for one source logical volume, the expansion processing is repeated for these target logical volumes. In step B7, the logical volume expansion unit 302 performs the expansion processing (1) while designating the designated source logical volume. In step B8, the logical volume expansion unit 302 checks whether the processing (1) has been performed normally or not. If it has been successful (if affirmative), the operation terminates. If negative, an error message is displayed in step B10.

If it is determined in step B3 that the location of the target logical volume is in the disk array device which the logical volume expansion unit 302 belongs to and not in another disk array device, the procedure proceeds to step B9. In step B9, the logical volume expansion unit 302 designates the logical volume and performs the expansion processing (1). The procedure then returns to step B5. If it is determined that the processing has not been performed normally (if negative) in step B5 or step B8, the logical volume expansion unit 302 displays an error message in step B10. Further, the logical volume expansion unit 302 performs in step B1 the processing (2) as cutback processing. The operation terminates after the cutback processing. If it is determined that the instruction is not from the logical volume expansion operating unit 102 in step B1, the logical volume expansion unit 302 proceeds to step B12. In step B12, the logical volume expansion unit 302 performs the processing (4) and then terminates the operation.

The processing (1), that is, the expansion operation for the logical volumes and the difference maps will be described with reference to FIG. 8. The logical volume expansion unit 302 resets the processing result and sets the processing result to normal. In step C1, the logical volume expansion unit 302 checks whether a designated logical volume is expandable or not. If affirmative, the procedure proceeds to step C2, whereas if negative, the procedure proceeds to step C14. In step C2, the logical volume expansion unit 302 checks whether the designated logical volume has a difference map or not. If affirmative, the procedure proceeds to step C3, whereas if negative, the procedure proceeds to step C7. The logical volume expansion unit 302 locks the difference map of the designated logical volume in step C3, expands the capacity of the difference map in step C4, and unlocks the difference map in step C5.

In step C6, the logical volume expansion unit 302 checks if these difference map expansion operations have been performed normally. If affirmative, the procedure proceeds to step C7, while if negative proceeds to step C14. In step C7, the logical volume expansion unit 302 expands the capacity of the designated logical volume. In step C8, the logical volume expansion unit 302 checks whether the capacity expansion of the logical volume has been performed normally. If affirmative, the procedure proceeds to step C9, whereas if negative, the procedure proceeds to step C10. In step C9, the logical volume expansion unit 302 updates the post-expansion size in the logical volume management table. Upon completion of the processing (1), the procedure returns to the original operational flow.

If it is determined in step C8 that the expansion operation of the logical volume has not been performed normally, the procedure proceeds to step C10. In step C10, the logical volume expansion unit 302 checks if the designated logical volume has a difference map. If affirmative, the procedure proceeds to step c11, whereas if negative, the procedure proceeds to step c14. The logical volume expansion unit 302 locks the difference map of the designated logical volume in step C11, and reduces (cuts back) the difference map in step C12. After unlocking the difference map in step C13, the procedure proceeds to step C14. In step C14, the logical volume expansion unit 302 displays an error message as the processing result, and then returns to the original operational flow.

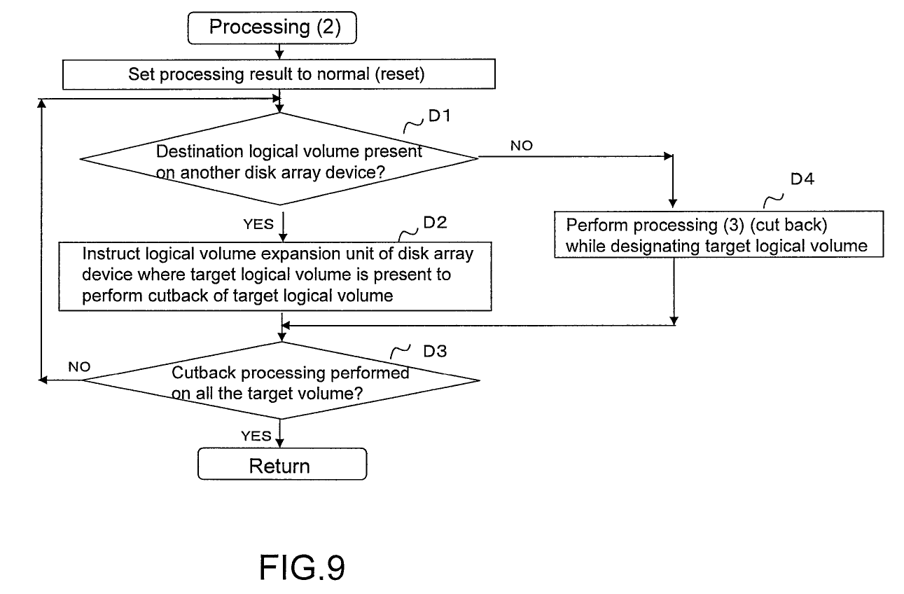

The processing (2), that is, the cutback operation for the target logical volume will be described with reference to FIG. 9. The logical volume expansion unit 302 resets the processing result to normal. In step D1, the logical volume expansion unit 302 checks whether or not the designated target logical volume is present in another disk array device. If affirmative, the procedure proceeds to step D2, whereas if negative, the procedure proceeds to step D4. In step D2, the logical volume expansion unit 302 instructs the logical volume expansion unit 402 of the disk array device in which the target logical volume is present to cut back the target logical volume.

In step D4, the logical volume expansion unit 302 performs the cutback processing (3) while designating the target logical volume in the disk array device, and returns to step D3. In step D3, the logical volume expansion unit 302 checks whether all the target logical volumes have been cut back. If negative, the logical volume expansion unit 302 returns to step D1 and performs the cutback processing on the remaining target logical volumes. If affirmative, the logical volume expansion unit 302 terminates the operation of the processing (2) and returns to the original operational flow.

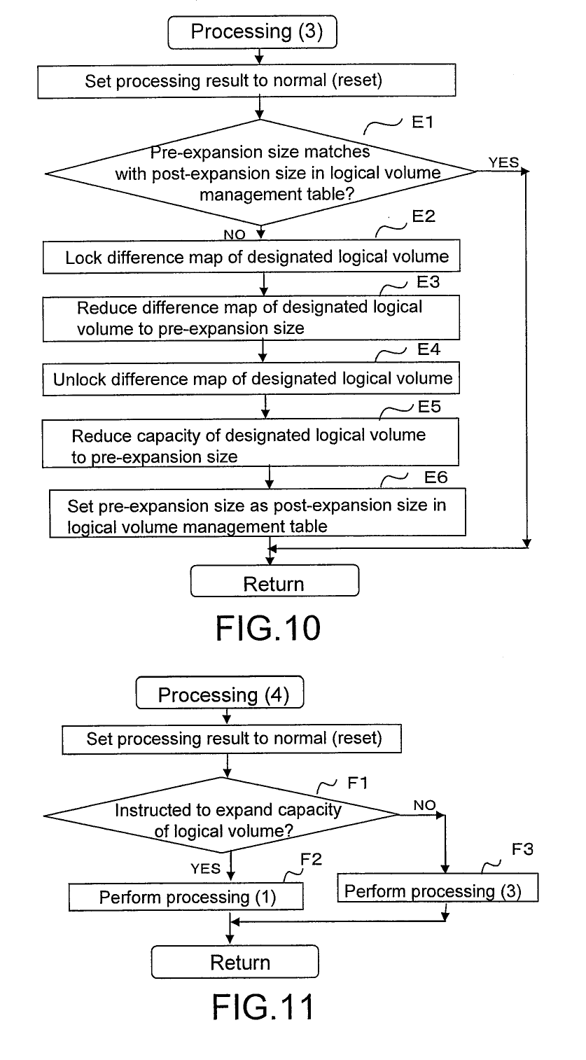

The processing (3), that is, the cutback operation of the difference maps and the logical volumes will be described with reference to FIG. 10. The logical volume expansion unit 302 resets the processing result to normal. In step E1, the logical volume expansion unit 302 checks whether the pre-expansion size and the post-expansion size match each other in the logical volume management table. If negative, the procedure proceeds to step E2 whereas, if affirmative, returns to the original operational flow without performing the cutback processing.

The logical volume expansion unit 302 locks the difference map of the designated logical volume in step E2, and reduces the difference map to the pre-expansion size in step E3. Further, in step E4, the logical volume expansion unit 302 unlocks the difference map. In step E5, the logical volume expansion unit 302 reduces the capacity of the designated logical volume to the pre-expansion size. Further, in step E6, the logical volume expansion unit 302 sets the value of the pre-expansion size as the post-expansion size of the logical volume management table. The logical volume expansion unit 302 terminates the operation of the processing (3) and returns to the original operational flow.

The processing (4), that is, the expansion operation for the logical volumes and the difference maps will be described with reference to FIG. 11. The logical volume expansion unit 302 resets the processing result to normal. In step F1, the logical volume expansion unit 302 checks whether or not the instruction is to expand the capacity of the logical volume. If affirmative, the procedure proceeds to step F2 whereas, if negative, the procedure proceeds to step F3. In step F2, the logical volume expansion unit 302 performs the expansion processing (1). In step F3, the logical volume expansion unit 302 performs the cutback processing (3). After terminating the operation, the logical volume expansion unit 302 returns to the original operational flow.

According to the present invention, the capacities of the source and target logical volumes and their difference maps can be expanded while maintaining the pair relation between the source and target logical volumes, and maintaining the difference map information. Since the difference map information is maintained, the BACKUP and RESTORE after the capacity expansion can be performed by partial replication without the need of full replication. This provides an advantageous effect of shortening the period of time required for replication. Further, since the operation can be performed in the BACKUP mode, the system is allowed to have a high fault tolerance.

The post-expansion size is stored as expansion information in the logical volume management table. The operation is suspended at any desired time such as a break of the work, so that the expansion information of the logical volume management table is returned to the server's OS to cause the OS to recognize the capacity expansion. This makes it possible to suspend the operation at any desired time and to shorten the operation suspension period. According to the first embodiment of the invention, a storage system requiring short replication time can be obtained.

### Second Embodiment

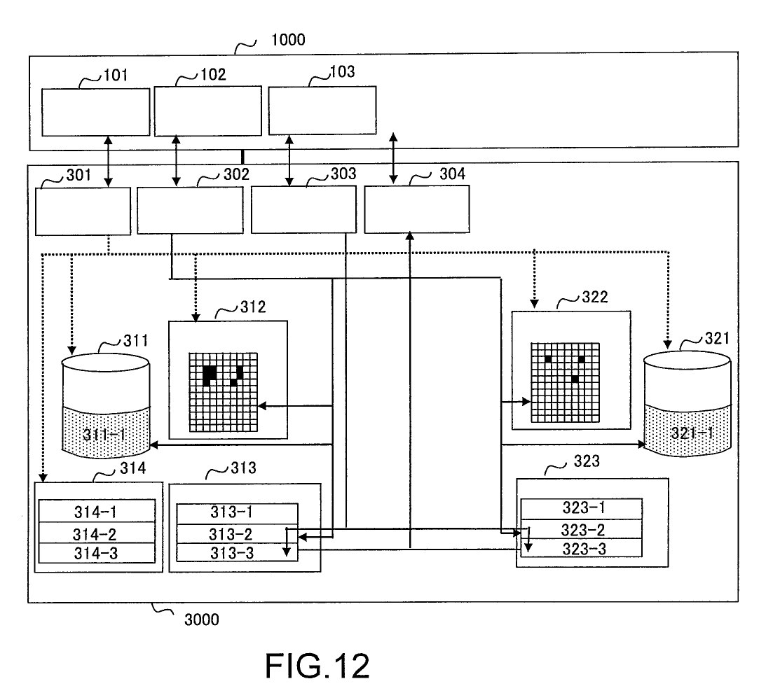

A second embodiment of the present invention will be described in detail with reference to FIG. 12. FIG. 12 shows a system block diagram according to the second embodiment. In the second embodiment, the logical volume replication function is applied to logical volumes in one and the same disk array device.

As shown in FIG. 12, the system is composed of a server 1000 and a disk array device 3000. The server 1000 is a server to operate a business application, a backup application and the like. The disk array device 3000 is connected to the server 1000 through a fiber channel, and has a logical volume replication function. The server 1000 has a pair operating unit 101, a logical volume expansion operating unit 102, and a logical volume expansion recognition operating unit 103. These units provided in the server 1000 and their operations are the same as those described in relation to the first embodiment, and the description thereof will be omitted.

The disk array device 3000 has a pair control unit 301, a logical volume expansion unit 302, a logical volume information setting unit 303, and a logical volume information returning unit 304. The disk array device 3000 further has logical volumes 311 and 321, difference maps 312 and 322, logical volume management tables 313 and 323, and a pair management table 314. In this embodiment, the logical volume 311 in the disk array device serves as a source logical volume, the logical volume 321 serves as a target logical volume, and these are in a pair relation.

The units in the disk array device 3000 operate in the same manner as described in relation to the first embodiment except for the pair control unit 301 and the logical volume expansion unit 302. The pair control unit 301 and the logical volume expansion unit 302 are additionally provided with functions to control the target logical volume 321 and the difference map 322 and to expand the capacity thereof. Therefore, the following description will be made only of the pair control unit 301 and the logical volume expansion unit 302. The other units are similar to their counterparts in the first embodiment, and the particulars thereof will be easily understandable. Therefore, the description of these units will be omitted.

Pair Control Unit 301:

The pair control unit 301 has functions to establish or cancel the pair relation of a logical volume designated by the pair operating unit 101, and to perform BACKUP or RESTORE on logical volumes in a pair relation. When instructed to establish a pair relation, the pair control unit 301 computes a necessary size for the difference maps based on a pre-expansion size set in the logical volume management tables 313 and 323 in the logical volumes 311 and 321. After obtaining the required size for the difference maps, the pair control unit 301 generates the difference map 312 and 322, and turns differential information bits ON. The paired logical volumes 311 and 321 have the same size. The pair control unit 301 obtains a required size for the pair management table 314, and sets source volume information 314-1, target volume information 314-2, and pair information 314-3 therein.

When instructed to cancel the pair relation, the pair control unit 301 releases the difference maps 312 and 322, and the pair management table 314. When instructed to perform BACKUP or RESTORE, the pair control unit 301 compares a logical OR of the difference maps 312 and 322 and updates the logical volume with data in a block in which the differential information bits are ON. When performing BACKUP, the pair control unit 301 updates data from the source logical volume 311 to the target logical volume 321. When performing RESTORE, he pair control unit 301 updates data from the target logical volume 321 to the source logical volume 311.

Logical Volume Expansion Unit 302:

The logical volume expansion unit 302 has a function to expand the capacity of a logical volume designated by the volume expansion operating unit 102 of the server 1000. When the logical volume 311 is not paired, the logical volume expansion unit 302 expands the logical volume 311. If the logical volume is expandable into a continuous region, the logical volume expansion unit 302 expands it into the continuous region. If the logical volume is not expandable into a continuous region, the logical volume expansion unit 302 allocates a separate region as an expansion region and expands the logical volume into this region. In this case, the blocks in the logical volume form one continuous region. The logical volume expansion unit 302 sets a post-expansion size as the actual data size in the logical volume management table 313.

When the logical volume 311 is in a pair relation, the logical volume expansion unit 302 checks whether or not the difference map 322 of the target logical volume 321 is expandable into a continuous region while maintaining the differential information. If expandable, the logical volume expansion unit 302 expands it into the continuous region. If not expandable into a continuous region, the logical volume expansion unit 302 generates a new difference map, copies the existing differential information therein, and then destroys the old difference map. Since the expanded portion of the logical volume is initialized, the difference becomes zero. Therefore, the differential information bits are not required to be turned ON in the expanded portion of the difference map. Further, since the difference map is accessed during work-related IO processing, lock control should be performed appropriately. If failed in expansion, the logical volume expansion unit 302 returns an error message.

The logical volume expansion unit 302 then checks whether the capacity of the target logical volume is expandable or not. If it is expandable into a continuous region, the logical volume expansion unit 302 expands the target logical volume into the continuous region. If not expandable into a continuous region, the logical volume expansion unit 302 allocates a separate region as an expansion region and expands the target logical volume into the expansion region. In this case, the blocks in the logical volume form one continuous region. If the capacity of the logical volume is not expandable due to insufficient physical disk space, the logical volume expansion unit 302 cuts back the difference map 322 of the target logical volume 321 and returns an error message.

The logical volume expansion unit 302 then checks whether or not the difference map 312 of the source logical volume 311 is expandable into a continuous region while maintaining the differential information. If expandable, the logical volume expansion unit 302 expands it into a continuous region. If not expandable into a continuous region, the logical volume expansion unit 302 generates a new difference map, copies the existing differential information therein, and then destroys the old difference map. Since the expanded portion of the logical volume is initialized, the difference becomes zero. Therefore, differential information bits are not required to be turned ON in the expanded portion of the difference map. Further, since the difference map is accessed during work-related IO processing, lock control should be performed appropriately. If failed in expansion, the logical volume expansion unit 302 cuts back the difference map 322 of the target logical volume 321 and the capacity of the logical volume 321, and returns an error message.

The logical volume expansion unit 302 then checks whether the capacity of the source logical volume 311 is expandable or not. If expandable into a continuous region, the logical volume expansion unit 302 expands the source logical volume 311 into the continuous region. If not expandable into a continuous region, the logical volume expansion unit 302 allocates a separate region as an expansion region and expands the target logical volume into the expansion region. In this case, the blocks in the logical volume form one continuous region. If the capacity of the logical volume is not expandable due to insufficient physical disk space, the logical volume expansion unit 302 performs a cutback and returns an error message. The cutback is performed on the difference map 322 of the target logical volume 321, the capacity of the target logical volume 322, and the difference map 312 of the source logical volume 311.

According to the second embodiment, logical volumes in the same disk array device are paired with each other. The pair control between the source and target logical volumes and the capacity expansion control thereof can be performed by means of the pair control unit 301 and the logical volume expansion unit 302 described above. Therefore, according to the second embodiment as well, the capacity of the source and target logical volumes can be expanded while maintaining the pair relation between the source and target logical volumes and the difference map information thereof. Thus, the second embodiment also provides the same advantageous effects as the first embodiment.

The present invention provides a capacity expansion control method for a storage system which is capable of expanding the capacity of the source and target logical volumes and their difference maps while maintaining the pair relation between the source and target logical volumes and the difference map information thereof.

The capacity expansion control method for a storage system of the present invention may have a first step in which the pair relation between the source and target logical volumes and the difference maps thereof are maintained by a pair control unit, and the capacities of the source and target logical volumes and the difference maps thereof are expanded by a logical volume expansion unit.

The capacity expansion of the difference maps in the first procedure step may be performed such that, if the difference map is expandable into a continuous region continuing from the region where the difference map is present, while maintaining the differential information, the difference map is expanded into the continuous region. If not expandable into the continuous region, an expanded difference map is newly generated in a separate region, the old differential information before the expansion is copied therein, and the difference map before the expansion is destroyed. The capacity expansion of the logical volume in the first step may be performed such that the logical volume is expanded into a continuous region continuing from the region where the logical volume is present, if the continuous region is expandable into such a continuous region. If not expandable into the continuous region, a region separate from the region where the logical volume is present is used as an expansion region and the logical volume is expanded into this expansion region.

The server for controlling the storage system is able to implement the first procedure step of capacity expansion during operation of a business application. In the first procedure step of expanding the capacity, the capacity of the difference map and the logical volume of the target logical volume are expanded, the target logical volume size after the capacity expansion is set in the target logical volume management table. Subsequently, the capacity of the difference map and the logical volume of the source logical volume are expanded, and the source logical volume size is set in the source logical volume management table.

Further, the method may further include a second procedure step in which, after the implementation of the first step of capacity expansion, the logical volume size after the capacity expansion is set as a return data size in the logical volume management table, and the return data size is returned to the operation system (OS) of the server to cause the same to recognize the logical volume size after the capacity expansion. The second procedure step can be implemented in the state in which the server suspends operation of the business application. Further, when the source logical volume and the target logical volume are controlled by the source and target servers, respectively, the second procedure step can be implemented such that the logical volume size after the capacity expansion of the source logical volume is recognized in the state in which the source server has suspended the operation of the business application, and the logical volume size after the capacity expansion of the target logical volume is recognized in the state in which the source server has resumed the operation of the business application.

The present invention provides a storage system having a pair control unit for controlling establishment and cancellation of a pair relation and BACKUP/RESTORE between a source logical volume and a target logical volume; and a logical volume expansion unit for expanding capacities of logical volumes and difference maps of the source and target logical volumes, wherein the pair control unit establishes a pair relation between specific source and target logical volumes, and the logical volume expansion unit is able to expand the capacities of the logical volumes and difference maps of the source and target logical volumes paired by the pair control means.

The storage system according to the present invention may further have a logical volume information setting unit for setting the post-expansion size of an expanded logical volume capacity of the paired source and target logical volumes as a return data size, and a logical volume management table for storing the return data size. The storage system may further have a logical volume information returning unit for returning the return data size to an operation system of the server to cause the operation system of the server to recognize the same.

According to the present invention, as described above, the capacity of the source and target logical volumes and the difference maps thereof can be expanded while maintaining the pair relation between the source and target logical volumes and the difference map information thereof. Further, the capacity expansion information can be held in the logical volume management table so that the server's OS is caused to recognize the capacity expansion at any desired time.

According to the present invention, since the pair relation and the difference map are maintained, BACKUP and RESTORE after the capacity expansion can be performed by partial replication without the need of full replication. Therefore, the period of time required for replication can be shortened. Further, since the operation can be performed in the BACKUP state, the system is allowed to have a high fault tolerance. Suspending the operation at any desired time such as a break of the operation, the post-expansion size can be returned to the server's OS to cause the OS to recognize the capacity size after the expansion. Thus, the operation can be suspended at any desired time and the period of time for which the operation is suspended can be shortened.

Still further, according to the present invention, the capacity expansion can be performed more easily by a reduced number of steps, and thus the chances of possible troubles can be reduced. The logical volumes in the pair relation can be entirely expanded by activating one logical volume expansion operation unit. Unlike the related art, the present invention is able to perform, in a single step, the series of operational steps consisting of cancellation of the pair relation, capacity expansion of the target logical volume, capacity expansion of the source logical volume, establishment of pair relation, and BACKUP operation.

The present invention as described above provides an expansion control method which is capable of expanding the capacities of the source and target logical volumes and the difference maps thereof in the state in which the pair relation between the source and target logical volumes and the difference map information are maintained. Therefore, the present invention provides a storage system having reduced replication time for which the system operates by this capacity expansion control method, and having high fault tolerance.

Although the present invention has been specifically described based on the preferred embodiments thereof, the invention is not limited to these embodiments. Obviously, various changes and modifications may be made without departing from the scope of the invention and all these changes and modifications are intended to be within the scope of the invention.

What is claimed is:

1. A capacity expansion control method for a storage system, wherein capacities of source and target logical volumes which are in a pair relation and difference maps thereof are expanded while maintaining the pair relation between the source and target logical volumes and the difference map information thereof.

2. The capacity expansion control method for a storage system according to claim 1, comprising a first step in which the pair relation between the source and target logical volumes and the difference maps thereof are maintained by a pair control unit, and the capacities of the source and target logical volumes and the difference maps thereof are expanded by a logical volume expansion unit.

3. The capacity expansion control method for a storage system according to claim 2, wherein the capacity expansion of the difference maps in the first step is performed, while maintaining the differential information, such that if the difference map is expandable into a continuous region continuing from a region where the difference map is present, the difference map is extended into the continuous region, whereas if not extendible into the continuous region, an expanded difference map is newly generated in a separate region, the old differential information before the expansion is replicated thereinto, and then the old difference map before the expansion is destroyed.

4. The capacity expansion control method for a storage system according to claim 2, wherein the capacity expansion of the logical volumes in the first step is performed such that if the logical volume is expandable into a continuous region continuing from a region where the logical volume is present, the logical volume is expanded into the continuous region, whereas if not expandable into the continuous region, the logical volume is expanded into a separate region away from the region where the logical volume is present.

5. The capacity expansion control method for a storage system according to claim 2, wherein the first step of capacity expansion is performed while a server controlling the storage system is operating a business application.

6. The capacity expansion control method for a storage system according to claim 2, wherein the first step of capacity expansion comprises:
expanding capacities of on the difference map and the logical volume of the target logical volume;
setting the size of the target logical volume after the capacity expansion in a target logical volume management table;
expanding capacities of the difference map and the logical volume of the source logical volume; and
setting the size of the source logical volume after the capacity expansion in a source logical volume management table.

7. The capacity expansion control method for a storage system according to claim 2, comprising a second step in which, after completion of the first step of capacity expansion, the logical volume size after the capacity expansion is set as a return data size in a logical volume management table, the return data size is returned to an operation system (OS) of the server to cause the same to recognize the logical volume size after the capacity expansion.

8. The capacity expansion control method for a storage system according to claim 7, wherein the second step of causing the OS to recognize the logical volume size after the capacity expansion is implemented in the state in which the server has suspended operation of a business application.

9. The capacity expansion control method for a storage system according to claim 7, wherein when the source logical volume and the target logical volume are controlled by a source server and a target server, respectively, the second step of causing the OS to recognize the logical volume size after the capacity expansion is implemented such that the recognition of the logical volume size after the capacity expansion of the source logical volume is performed in the state in which the source server has suspended operation of a business application, and the recognition of the logical volume size after the capacity expansion of the target logical volume is performed in the state in which the source server has resumed operation of the business application.

10. A storage system comprising:
a pair control unit for controlling establishment and cancellation of a pair relation and BACKUP/RESTORE between a source logical volume and a target logical volume; and
a logical volume expansion unit for expanding capacities of the logical volumes and difference maps of the source and target logical volumes,
wherein the pair control unit establishes a pair relation between specific source and target logical volumes, and the logical volume expansion unit expands the capacities of the logical volumes and the difference maps of the paired source and target logical volumes while maintaining the pair relation established by the pair control unit.

11. The storage system according to claim 10, further comprising:
a logical volume information setting unit for setting, as a return data size, the post-expansion size of the expanded capacity of the logical volumes of the paired source and target logical volumes; and
a logical volume management table for storing the return data size.

12. The storage system according to claim 11, further comprising a logical volume information returning unit for returning the return data size to an operation system of the server, wherein the return data size is returned to the operation system of the server to cause the operation system to recognize the data size.
